(19) United States
(12) Patent Application Publication
(10) Pub. No.: US 2006/0237389 A1
(43) Pub. Date: Oct. 26, 2006

(54) Method for fabricating interlayer conducting structure of circuit board

(76) Inventors: E-Tung Chou, Hsin-chu (TW); Chia-Yuan Yu, Hsin-chu (TW)

Correspondence Address: SAWYER LAW GROUP LLP, P O BOX 51418, PALO ALTO, CA, 94303, US

(21) Appl. No.: 11/411,358

(22) Filed: Apr. 25, 2006

(30) Foreign Application Priority Data
Apr. 26, 2005 (TW) 094113200

(51) Int. Cl. H01B 13/00

(52) U.S. Cl. 216/13

(57) ABSTRACT

A method for fabricating an interlayer conducting structure of a circuit board is proposed. The method includes providing a core layer, and a first insulating layer and a second insulating layer formed on the upper and lower surfaces of the core layer successively, forming a through hole penetrating the core layer and the first and second insulating layers, and filling the through hole with a conductive material; removing the second insulating layer, a portion of the conductive material in the through hole at a position corresponding to the second insulating layer, and the first insulating layer; and pressing a metal layer onto the first and second surfaces of the core layer such that the conductive material protruded from the through hole corresponding to the core layer is fully packed in the through hole, so as to form a conductive through hole.

### CROSS-REFERENCE TO RELATED APPLICATION

This application claims benefit under 35 USC 119 of Taiwan Application No. 094113200, filed Apr. 26, 2005.

### FIELD OF THE INVENTION

The present invention relates to a method for fabricating an interlayer conducting structure of circuit board, and more particularly, to a method for fabricating an interlayer conducting structure of a conductive through hole which provides electrical connection between the interlayer of the circuit board.

### BACKGROUND OF THE INVENTION

Following the blooming development of electrical products, the electrical products are gradually becoming multi-functional with high performance. To satisfy requirements of integration and miniaturization of semiconductor chip packaging which provide more connection between active, passive elements and circuits. Moreover, a circuit board is also gradually becoming a multi-layer board from a double-layer board under restricted spaces, such that change increases circuit layout surface area by interlayer connection technology. As the result, requirements for integrated circuit are coordinated and the thickness of the circuit board is reduced, so as to contain more circuits and elements on surface with same surface area.

Moreover, according to operational requirements of microprocessor, chip packaging and chipset, a circuit board with circuit is required to enhance functions such as chip message transmitting, bandwidth improving and impedance controlling to achieve development of input/output packaging. However, to meet requirements of a semiconductor chip package with developments of slim, multi-function, high speed and high frequency, development of a circuit board is favoring fine line and small aperture. The current fabrication of circuit board has shortened circuit from 100 micrometer to 30 micrometer, and the fabrication comprises of circuit width, space and aspect ratio. The development continues favoring smaller circuit precision.

A build-up technology is developed to increase precision of wire layout of a circuit board, such that a plurality of insulating layers and wire layers are built on surface of a core circuit board by build-up process. Additionally, a conductive through hole is formed on the insulating layer to provide electrical connection between upper and lower wire layer. The quality of the core circuit board is critical factor affecting entire performance of the circuit board.

Referring to FIGS. 1A to 1E are traditional fabrication of circuit board. First of all, a resin-coated copper 101 (RCC) such as a metal pressing core board 100 is provided and a plurality of through holes 102 are formed in the core board. Referring to FIG. 1A, a metal layer 103 is deposited on the walls of the through holes 102 and on the surface of the core board 100 by copper plating. Referring to FIG. 1B, the through holes 102 are filled with a conductive or a non-conductive material 11 such as insulating ink or copper conductive paste, to form plated through holes 102a (PTH), so as to electrically connect top and bottom surface of metal layer 103 on the core board 100. Referring to FIG. 1C, the redundant filling material 11 is removed by buffing. Referring to FIG. 1D, patterning process is performed on resin-coated copper 101(RCC) and the metal layer 103 of the core board 100. Referring to FIG. 1E, a circuit board with a double layer of circuit 104 is formed as a result of foregoing description.

However, the foregoing fabrication in prior-art spends more time on an electroplating process to form a metal layer on the wall of the through holes 102 and on the surface of the core board 100 to form a wire layer for the subsequent pattering process. Moreover, the plated through holes 102a in the through holes 102 are utilized to electrically conduct the wiring layer 104 on the surface of the core board 100, and the formation of filling material 11 in the through hole 102 is required to maintain surface regularity of the core layer 100. Therefore, the required time is increased for the fabrication.

On the other hand, a metal layer is required to form on the wall of the through holes on the core board during formation of the plated through holes 102a (PTH), such that metal layer is also formed on the surface of the core board and causes thickness of circuit to increase on the subsequent surface of the core board, therefore, fabricating a fine line is unable to be provided effectively.

Furthermore, the filling material 11 is directly filled in the through holes 102 of the core board for the foregoing fabrication in prior-art, such that method is unable to fully fill the entire hole, so a board cracking is happened during the subsequent heat cycle due to the air remained in the hole. The consequence seriously affects the reliability of the subsequent process. At the same time, the through hole is not fully filled with filling material 11 which causes surface irregularity of a circuit board, so as to increase difficulty of performing subsequent process on the circuit board.

Therefore, providing a method for fabricating interlayer conducting structure of circuit board to prevent long fabrication time, increased difficulty of subsequent process, low fabrication efficiency and low conductivity of circuit board caused by electroplating known in the prior-art technology, is remained as a problem to be solved.

### SUMMARY OF THE INVENTION

In light of the above drawbacks, a primary objective of the present invention is to provide a method for fabricating an interlayer conducting structure of circuit board to simplify fabrication of conducting structure.

Another objective of the present invention is to provide a method for fabricating an interlayer conducting structure of circuit board to enhance efficiency of conducting structure and to lower difficulty of subsequent circuit board fabrication.

Still another objective of the present invention is to provide a method for fabricating an interlayer conducting structure of circuit board to enhance electrical conductivity and reliability of circuit board.

A further objective of the present invention is to provide a method for fabricating an interlayer conducting structure of circuit board to prevent drawbacks of fine line caused by an increased thickness of wires while formation of a metal layer on the wall of a through hole during plated through hole formation known in the prior-art.

In accordance with the foregoing and other objectives, the present invention proposes a method for fabricating an interlayer conducting structure of circuit board, comprising: providing a core layer with a first surface and an opposing second surface, respectively forming a first insulating layer and a second insulating layer on the first and second surface of the core layer successively, forming at least one through hole penetrating the core layer, the first second insulating and the second insulating layer, and filling the through hole with a conductive material; removing the second insulating layer and a portion of the conductive material in the through hole at a position corresponding to the second insulating layer; removing the first insulating layer, so as to allow the conductive material to be protruded from the through hole at a position corresponding to the core layer; and pressing a metal layer onto the first and second surfaces of the core layer respectively such that the conductive material protruded from the through hole corresponding to the core layer is fully packed in the through hole, so as to form a conductive through hole. Then, the metal layers of the first and second surfaces of the core layer can be patterned to form wiring layers, and the wiring layers can be electrically connected with each other via the conductive through hole.

The present invention also proposes a method for fabricating an interlayer conducting structure of circuit board, wherein the circuit board comprises a core layer with a first surface and an opposing second surface; the core layer includes at least one through hole; and a metal layer is formed on the first surface and the second surface of the core layer. The method is characterized in that the metal layer is not formed in the through hole, and the interlayer conducting structure of the circuit board is formed by electrically connecting the metal layers on the first surface and the second surface of the core layer to each other via the conductive material only.

The present invention demonstrates a formation of a conductive through hole by directly pressing a conductive material in the core layer. Thereby, the wiring layers on the first and on the second surface of the core layer can be electrically connected to each other via the conductive through hole. The required fabricating time can thus be shortened to prevent the drawback of long fabricating time caused by a conventional electroplating process, which forms metal material on the surface of the core layer and on the wall of the through hole follows by filling the through hole of the core layer with a conductive material to form a conductive through hole. Furthermore, the thick metal layer on the surface of the core layer can also be prevented from generating the disadvantage in the miniaturized wiring process.

In accordance with the present invention, since the first insulating layer and the second insulating layer are successively formed on the surfaces of the core layer followed by forming the through hole penetrating the core layer, the first and second insulating layers, the filling space of the conductive material for forming the conductive through hole is expanded by using the through hole in the first and second insulating layers on the surfaces of the core layer. After the conductive material is filled in the through hole, the second insulating layer, a portion of the conductive material in the position corresponding to the second insulating layer, and the first insulating layer are removed, so as to allow the conductive material to be protruded from the core layer. Then, the metal layer is directly pressed onto the first and second surface of the core layer to provide the metal layer for forming the wiring layer, such that the conductive material protruded from the through hole of the core layer can be fully packed in the through hole, so as to form the conductive through hole. Therefore, metal can be prevented from forming on the surface of the core layer and in the through hole to shorten the fabricating time and processing cycle of the product. Moreover, drawbacks of long fabricating time and bad reliability in the conventional technology caused by electroplating metal material on both the surfaces of the core layer and the wall of the through hole and then filling the through hole of the core layer with the conductive material can be thus prevented.

Moreover, the present invention forms the conductive through hole in the core layer by pressing the metal layer for forming the wiring layer onto the surfaces of the core layer to fully packed the conductive material protruded from the through hole of the core layer in the through hole; thereby, the conductive material protruded from the through hole of the core layer can be used to fully fill the through hole, so as to prevent the drawbacks of degrading the quality of the electroplated metal layer, decreasing the quality of connection between the wiring layers of the upper and lower surfaces of the core layer and even disconnecting the wires caused by the residue adhesive left on the wall of the through hole in the conventional technology.

Furthermore, in the present invention the second insulating layer on the surfaces of the core layer and the conductive material in the through hole thereof are removed by buffing, and the conductive material is fully packed in the through hole of the core layer by pressing, such that the top and bottom edges of the conductive material can be leveled with the surfaces of the core layer, so as to provide convenience for the subsequent process, and reducing difficulty of the subsequent process. Therefore, surface irregularity of a circuit board caused by an insufficient filling conductive material is prevented, and the drawback of uncontrollable quality for the subsequent process such as a build-up process is also prevented.

### BRIEF DESCRIPTION OF THE DRAWINGS

The present invention can be more fully understood by reading the following detailed description of the preferred embodiments, with reference made to the accompanying drawings, wherein:

FIGS. 1A to 1E are cross-sectional views which demonstrate a method for fabricating a circuit board with a double layer known in the prior-art;

FIGS. 2A to 2F are cross-sectional views of a method for fabricating an interlayer conducting structure of a circuit board in the present invention, and;

FIGS. 3A to 2C are cross-sectional views of a method for fabricating a subsequent circuit process to the circuit board structure in the present invention.

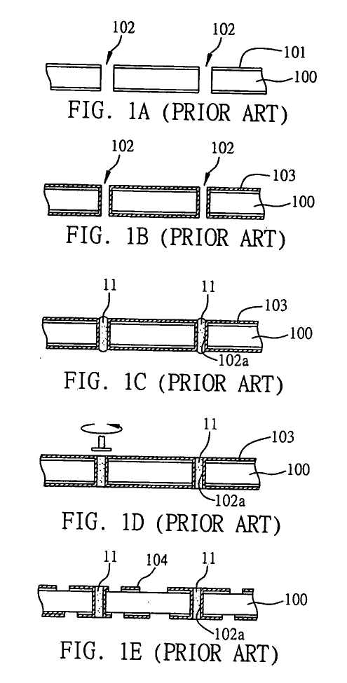

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

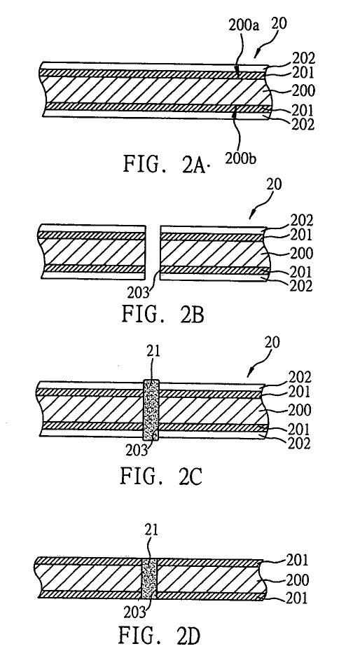

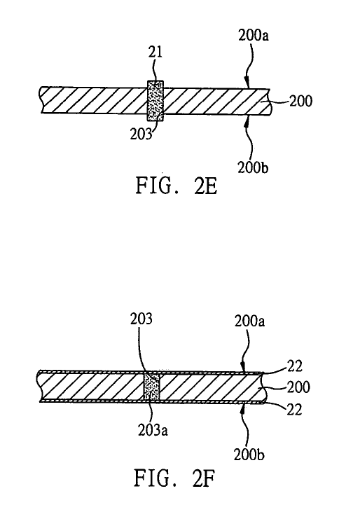

Referring to FIGS. 2A to 2F are flow charts of fabricating method of an interlayer conducting structure of a circuit board. The drawings demonstrate simplified views for fabricating a circuit board in the present invention. Additionally, the drawings only demonstrate elements related to the present invention, and the elements appeared in drawings of the present invention are not drawn as real numbers, shapes and sizes as in practice. The numbers, shapes and sizes are optional designs in practice, and arrangements of the elements can be more complicated.

Referring to FIG. 2A, first of all, a core layer 200 is provided and the core layer 200 has a first surface 200a and a second surface 200b corresponding to the first surface 200a. The core layer 200 can be an insulating layer made of bismaleimide triazine (BT), FR4 resin, epoxy resin, glass fiber, polyimide, and cyanate ester. Then, a first insulating layer 201 and a second insulating layer 202 are formed on the first surface 200a and the second surface 200b of the core layer successively; therefore, an insulating board 20 with the core layer 200, the first insulating layer 201 and the second insulating layer 202 is formed. According to the present embodiment, the first insulating layer 201 can be insulating tape which is formed on the first and second surface 200a and 200b of the core layer 200 by adhering. Moreover, the second insulating layer 202 is a release film such as PET. However, other insulating material with similar function can be used as the first and second insulating layer 201, 202 according to a practical fabrication.

Referring to FIG. 2B, a through hole 203 is penetrated in the core layer 200, the first insulating layer 201, and the second insulating layer 202 of the insulating board 20 by laser or drilling, such that the height of the first and second insulating layers 201, 202 provide sufficient space for a filling conductive material to form the subsequent conductive through hole.

Referring to FIG. 2C, a conductive material 21 is filled in the through hole 203 of the insulating board 20 and the conductive material 21 is protruded in the through hole 203. According to the embodiment of the present invention, a first and a second insulating layer 201, 202 are formed on the surface of the core layer 200, and a through hole 203 is penetrated in the core layer 200, the first and second insulating layer 201, 202, so as to provide sufficient space for a filling conductive material 21.

Referring to FIG. 2D, pre-cure is initially performed on the conductive material, then, the second insulating layer 202 and a portion of the conductive material 21 in the through hole 203 at the position corresponding to the second insulating layer 202 are removed by buffing after the conductive material 21 becomes semi-hardening.

Referring to FIG. 2E, the first insulating layer 201 is then removed, a portion of the conductive material 21 in the through hole 203 of the first insulating layer 201 is remained so as to protrude the conductive material 21 in the core layer 200.

Referring to FIG. 2F, a metal layer 22 is pressed onto the first and second surfaces 200a, 200b of the core layer 200, and the protruding conductive material 21 on the core layer 200 is fully filled in the through hole 203 to form a conductive through hole 203a. According to the present embodiment, the protruding conductive material 21 in the through hole 203 of the core layer 200 provides a sufficient quantity for pressing, such that protruding conductive material 21 in the through hole of the core layer 200 is fully pressed into the through hole 203 to enhance density, so as to form a conductive through hole 203a with good conductivity. Moreover, the temperature of pressing process can be utilized to complete post-cure of the conductive material. In addition, copper layer is the best material for the foregoing metal layer.

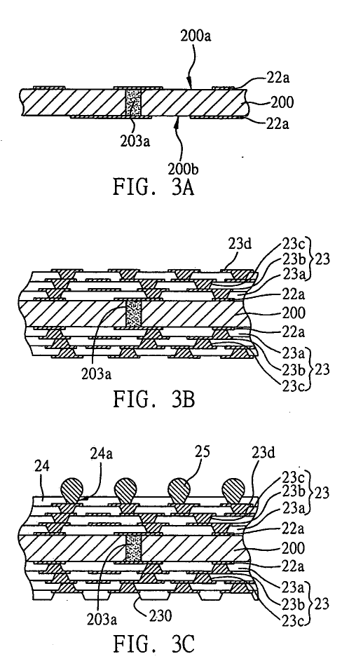

Finally, the post-process shown in FIGS. 3A to 3C can be performed on the structure of the foregoing fabrication. Firstly, a wiring layer 22a is formed on the first and second surfaces 200a, 200b of the core layer by performing a patterning process on the metal layer 22, and the wiring layer 22a on the surface of the core layer 200 is electrically connected via the conductive through hole 203a in the core layer 200 to form a circuit board with wires on the surface (as shown in FIG. 3A). Then, a build-up structure 23 is formed on the wiring layer 22a on the first and second surfaces 200a, 200b of the core layer 200. In addition, the build-up structure 23 comprises of a dielectric layer 23a, a wiring layer 23b stacked up on the dielectric layer 23a and a conducting structure 23c in the dielectric layer 23a. A portion of the conducting structure 23c is electrically connected to the wiring layer 22a and a connection pad 23d is formed on the surface of the build-up structure 23, so a circuit board with multi-wiring layer structure is formed (as shown in FIG. 3B). Moreover, a solder mask 24 is formed on the surface of the build-up structure 23, and the surface of the solder mask 24 has a plurality of openings 24a to expose the connection pad 23d on the build-up structure 23. A conductive element 25 electrically connected to the connection pad 23d is formed in the opening 24a of the solder mask 24, and the conductive element 25 can be solder ball or solder bump (as shown in FIG. 3C). Then, a semiconductor element can be connected to the circuit board and electrically conducted externally.

Therefore, the present invention of a method for fabricating an interlayer conducting structure of a circuit board is to provide a core layer and to form a first and second insulating layer on the first and second surfaces of the core layer successively. A through hole is formed in the core layer, the first and second insulating layers via drilling process and the through hole is filled with a conductive material to form a conductive through hole. Then, the second insulating layer, the conductive material in the through hole at the position corresponding to the second insulating layer, and the first insulating layer are removed. A metal layer is pressed onto the first and second surface of the core layer to protrude the conductive material in the through hole of the core layer and to fully fill the through hole with the conductive material to form a conductive through hole. The filling space for the conductive material to form the conductive through hole is increased via the height of the first and second surfaces of the core layer. After filling the core layer, and the through holes of the first and second insulating layer with the conductive material, the second insulating layer, the conductive material in the through hole at the position corresponding to the second insulating layer and the first insulating layer are removed. Then, a metal layer is directly pressed onto the first and second surfaces of the core layer to provide subsequent formation of a wiring layer, so as to fully fill the through hole of the core layer with the protruding conductive material to form a conductive through hole. Therefore, shorter fabricating time and fabricating cycle and preventing a usage of the electroplated metal material on the surface of the core layer and on the wall of the through hole during electroplating process known in the prior-art technology. Afterwards, the drawbacks of long fabricating time caused by filling the through hole of the core layer with conductive material is prevented as well as preventing the metal layer on the core layer becoming too thick for fabricating a thin circuit.

On the other hand, the present invention utilizes surface pressing of the core layer to provide the metal layer of the wiring layer for completely filling with protruding conductive material in the through hole of the core layer in the through hole of the core layer to form a conductive through hole. Therefore, the conductive material is filled in the through hole of the core layer to enhance conductivity of the conductive through hole. As the result, preventing poor quality of the electroplated metal layer caused by the deposit remained on the wall of the through hole known in the prior-art technology. Additionally, the foregoing description affects the conductivity of the top and bottom surfaces of the core layer and causes a drawback of breaking is prevented.

Moreover, the present invention utilizes removal of the conductive material in the through hole and on the second insulating layer of the core layer and the through hole of the core layer is filled with the pressed conductive material to maintain surface regularity of the core layer and the conductive material, to provide convenience for the subsequent process, and lowering difficulty of the subsequent process. Therefore, surface irregularity of a circuit board caused by an insufficient filling conductive material is prevented, and the drawback of uncontrollable quality for the subsequent process such as build-up process is also prevented.

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

What is claimed is:

1. A method for fabricating an interlayer conducting structure of a circuit board, comprising the steps of:
providing a core layer with a first surface and an opposing second surface, respectively forming a first insulating layer and a second insulating layer on the first and second surface of the core layer successively, forming at least one through hole penetrating the core layer, the first second insulating and the second insulating layer, and filling the through hole with a conductive material;
removing the second insulating layer and a portion of the conductive material in the through hole at a position corresponding to the second insulating layer;
removing the first insulating layer, so as to allow the conductive material to be protruded from the through hole at a position corresponding to the core layer; and

2. The method for fabricating an interlayer conducting structure of a circuit board of claim 1, further comprising:
patterning the metal layers of the first and second surfaces of the core layer to form wiring layers on the first and second surfaces of the core layer, wherein the wiring layers are electrically connected to each other via the conductive through hole.

3. The method for fabricating an interlayer conducting structure of a circuit board of claim 2, further comprising:
respectively forming a build-up structure on the first and second surfaces of the core layer and the wiring layers formed thereon, wherein a plurality of conducting structures are formed in the build-up structure to electrically connect with the wiring layers, and a connection pad is formed on a surface of the build-up structure.

4. The method for fabricating an interlayer conducting structure of a circuit board of claim 3, further comprising:
forming a solder mask on the surface of the build-up structure, wherein a surface of the solder mask has formed with a plurality of openings to expose the connection pad of the build-up structure.

5. The method for fabricating an interlayer conducting structure of a circuit board of claim 4, wherein the build-up structure comprises a dielectric layer, a wiring layer provided over the dielectric layer, and a conducting structure formed in the dielectric layer.

6. The method for fabricating an interlayer conducting structure of a circuit board of claim 5, further comprising:
forming a conductive element in each of the openings of the solder mask to electrically connect with the connection pad.

7. The method for fabricating an interlayer conducting structure of a circuit board of claim 6, wherein the conductive element is a solder ball.

8. The method for fabricating an interlayer conducting structure of a circuit board of claim 1, wherein the core layer is an insulating layer.

9. The method for fabricating an interlayer conducting structure of a circuit board of claim 1, wherein the first insulating layer is a tape.

10. The method for fabricating an interlayer conducting structure of a circuit board of claim 1, wherein the second insulating layer is a release film.

11. The method for fabricating an interlayer conducting structure of a circuit board of claim 1, wherein the metal layer is a copper layer.

12. The method for fabricating an interlayer conducting structure of a circuit board of claim 1, wherein the first insulating layer is formed on the first and second surfaces of the core layer by adhering.

13. The method for fabricating an interlayer conducting structure of a circuit board of claim 1, wherein the portion of conductive material in the through hole at the position corresponding to the second insulating layer is removed by buffing.

14. The method for fabricating an interlayer conducting structure of a circuit board of claim 1, wherein the conductive material is pre-cured to a substantially solid state prior to removing the second insulating layer, the conductive material in the through hole at the position corresponding to the second insulating layer, and the first insulating layer.
